(19) United States
(12) Patent Application Publication
(10) Pub. No.: US 2021/0158393 A1
(43) Pub. Date: May 27, 2021

(54) Systems and Methods for Tracking Advertisement Efficacy Under Consumer Transactions

(71) Applicants: Jeffrey W. Mankoff, Dallas, TX (US); Neil Keon, Dallas, TX (US)

(72) Inventors: Jeffrey W. Mankoff, Dallas, TX (US); Neil Keon, Dallas, TX (US)

(21) Appl. No.: 17/168,486

(22) Filed: Feb. 5, 2021

Related U.S. Application Data
(63) Continuation-in-part of application No. 16/261,020, filed on Jan. 29, 2019.
Application No. 16/261,020 is a continuation of application No. 14/553,557, filed on Nov. 25, 2014, now abandoned.
(60) Provisional application No. 61/908,962, filed on Nov. 26, 2013.

(51) Int. Cl. G06Q 30/02

(52) U.S. Cl. CPC G06Q 30/0246; G06Q 30/0261

(57) ABSTRACT

A technique for tracking advertisement efficacy using consumer transactions is disclosed. An information tracking agent maintains and stores information related to users identified by a unique identifier. A user is presented with an online/offline advertisement. An information tracking agent records and stores the advertisement transaction. When a user performs a transaction for purchase of goods or service that are the subject of the advertisement, the information tracking agent identifies the user with the unique identifier and the matching agent matches the user transaction with the displayed advertisement. The system automatically tracks the effectiveness of the advertisements displayed to users without requiring consumer action, beyond the purchase/transaction, in response to the displayed advertisement. In another embodiment, the system automatically tracks user location with a GPS and dynamically displays advertisements on billboards connected to the information tracking agent.

### RELATED APPLICATIONS

This application is a continuation-in-part of U.S. patent application Ser. No. 16/261,020, filed Jan. 29, 2019, which is a continuation of U.S. patent application Ser. No. 14/553,557, filed Nov. 25, 2014, which claims priority to and is a non-provisional conversion of U.S. Provisional Patent Application Ser. No. 61/908,962, filed Nov. 26, 2013, each of which are incorporated herein by reference in their entirety for all purposes.

### TECHNICAL FIELD

The invention relates to tracking advertisement efficacy using consumer transactions, and more specifically to tracking transactions without a user action when presented with an advertisement.

### BACKGROUND

The present inventor has derived a number of patents, as well as other intellectual property, that enables automatic redemption of virtual offers or other documents, as well as automated loyalty or rewards programs to be operated using mobile telephone numbers, email addresses, and/or unique identifiers matched to a user's payment vehicle, such as credit card numbers or other types of payment vehicles. Such technologies provide a basis for offering various loyalty program benefits and promotional offers to consumers on behalf of merchants, including retailers and restaurant operators. The various implementations that exist or could be constructed to reflect those inventions and innovations comprise the Voupon and vPromos technology. Among the patents and patent applications implemented in this technology include: U.S. Pat. Nos. 6,385,591; 6,868,426; 7,593,862; 7,870,021; 8,036,934; 8,140,386; 8,244,580; 8,484,078; as well as U.S. Published Patent Application Nos. 2005/0071230; 2005/0075932; 2012/0066041; 2012/0310721; 2013/0297395. The above-identified patents and patent applications are incorporated herein by reference in their entirety for all purposes.

In the online world, affiliate marketing allows for an online retailer to set up an affiliate program for the purpose of driving traffic to the online retailer. For example, a consumer on the Internet may be browsing on a fishing website, and on this fishing website a banner ad displays to the consumer for fishing lures sold at Amazon.com®. The consumer may click the banner ad, and thus be redirected to the Amazon.com® website. In this existing approach, because the fishing website is in the Amazon affiliate program, if a purchase is made by the consumer at Amazon.com® resulting from that click of the banner ad, Amazon can track that click back to the fishing website, and thus the effectiveness of the banner ad displayed to the consumer may be determined.

Presently, however, there is no way to automatically track an online banner advertisement displayed to a consumer to a purchase made offline by the consumer in response to the displayed banner ad. Furthermore, there is also no way to automatically track an offline advertisement displayed to a consumer to a purchase made on or offline by the consumer in response to that displayed advertisement. One conventional technique to track a displayed online advertisement or other offer to an offline purchase in response to that advertisement is for the advertiser/retailer to have a physical tracking mechanism that requires the consumer to take action, such as print a coupon, or a deliver a coupon or code to a mobile phone, or write down a promo code, each of which then is provided at time of check out. But in all such embodiments, the tracking of the efficacy of the advertisement or offer is not automatic and instead requires consumer action, other than the purchase of the good or service that is the subject of the advertisement. Another approach is to employ the technology disclosed in the patents and applications mentioned above. Such technology empowers a marketer or merchant to provide an offer that attaches to the consumer's payment system when that offer is “virtually clipped” by the consumer, and thus when the consumer pays for a product or service associated with that offer using the associated payment system, the purchase may be tracked back to the virtual advertisement or offer. However, even this technology requires consumer action in “clipping” or otherwise selecting the offer such that it is associated with the payment system that is later used in the purchase. In view of the currently available technologies, it would be advantageous to have systems and methods that track the effectiveness of advertising to consumers, by not requiring consumer action beyond the purchase of the good or service that is the subject of an advertisement displayed to the consumer.

While online advertising can target advertisements to consumers based upon search history and cookies, some advertisers, like those used in streaming TV, do not have similar insights to their subscribers' purchasing behavior, making it impossible to deliver relevant advertising to distinct subscribers. And for streaming TV services and online digital publishers and search engines, offline purchases also cannot be tracked. If a feedback loop could be created between the streaming TV service and a subscriber's purchasing behavior, both online and offline, that would provide data to allow for targeted, relevant advertising benefitting the digital publisher (e.g., streaming TV service), advertiser, merchant and each subscriber/consumer. In view of the deficiencies found in currently available technologies, it would be advantageous to have systems and methods that track the purchasing behavior and purchase data of consumers, and be able to deliver relevant, targeted advertisements by not requiring consumer action beyond the purchase of the good or service.

### SUMMARY

The principles disclosed herein allow an advertiser, whether it is a marketing company or agent or the merchant itself, to automatically track the effectiveness of the advertisements displayed to consumers without requiring consumer action, beyond the purchase, in response to the displayed advertisement. Thus, the principles disclosed herein partly provide a new technology that creates a history of transactions with anonymous identifiers that are unique to individuals and/or payment vehicles. However, the disclosed principles further provide new systems and methods, which may interact with existing technology, to track and match such transactions to advertisements or other promotional information presented to consumers via media and applications, and which may be delivered to consumers using any means, such as transmitted over computer and telecommunications networks, such as via email, banner ads, and the like, but also other technologies that may be used to display advertisements or promotional offers to potential consumers, such as interactive television, distributed network applications, broadcast media, billboards and related visual media, and even print media. Accordingly, the disclosed principles now allow the tracking of both online and offline purchases made in response to virtual advertisements, whether online or not, as well as non-virtual advertisements, such as print media or types of display media.

### BRIEF DESCRIPTION OF THE DRAWINGS

For a fuller understanding of the advantages provided by the invention, reference should be made to the following detailed description together with the accompanying drawings wherein:

FIG. 1 illustrates a diagram of one embodiment of Credit Card Transaction Pre-Processing that may be implemented with a system or method in accordance with the disclosed principles.

FIG. 2 illustrates a diagram of one embodiment of Credit Card Transaction Post-Processing that may be implemented with a system or method in accordance with the disclosed principles.

FIG. 2a illustrates a flowchart presenting an exemplary embodiment of user data collection and presentation in accordance with the disclosed principles.

FIG. 3 illustrates a diagram of one embodiment of Credit Card Transaction Logging, such as by the vPromos technology, but that may be implemented with a system or method in accordance with the disclosed principles.

FIG. 4 illustrates a diagram of one embodiment of a Consumer Response Transaction Log that may be implemented with a system or method in accordance with the disclosed principles.

FIG. 5 illustrates a diagram of one example of Receipt Messaging that may be implemented with a system or method in accordance with the disclosed principles.

FIG. 6 illustrates a diagram of one embodiment of Receipt Message Tracking that may be implemented with a system or method in accordance with the disclosed principles.

FIG. 7 illustrates a diagram of one embodiment of a Promotional Information Presenting and Response Tracking Log for an exemplary consumer that may be implemented with a system or method in accordance with the disclosed principles.

FIG. 8 illustrates a diagram of one embodiment of Credit Card Transaction Matching that may be implemented with a system or method in accordance with the disclosed principles.

FIG. 9 illustrates one embodiment of a system for the automatic tracking of consumer response to promotional information in accordance with the disclosed principles.

FIG. 10 illustrates an exemplary embodiment of a method for tracking of advertisement efficacy in accordance with the disclosed principles.

FIG. 11 illustrates an exemplary embodiment of a method for location-based tracking of advertisement efficacy in accordance with the disclosed principles.

FIG. 12 illustrates an exemplary embodiment of a system for location-based real time targeted advertising in accordance with the disclosed principles.

FIG. 13 illustrates a flowchart providing an exemplary embodiment of a process for location-based real time tracking of advertisement efficacy in accordance with the disclosed principles.

### DETAILED DESCRIPTION

Although the figures discussed below illustrate an exemplary embodiment of matching/tracking the providing of an advertisement to a consumer based on payment transaction, be it credit card, debit card, PayPal®, NFC Mobile wallet, cloud based, etc., or even a non-payment related consumer interaction with a merchant, any type of promotional information provided to a consumer may be tracked and matched to any type of consumer transaction related to that information by a system or method implemented in accordance with the disclosed principles. In advantageous embodiments, the consumer is identified by the disclosed system or method using some type of unique identifier associated with the consumer and provided to the disclosed system. For example, the identifier may be the consumer's name, telephone number, telephone identifier, Facebook® username, Twitter® handle, an account number, a biometric scan (e.g., fingerprint scan, retina scan, facial recognition scan, etc.), interactive television identifier, or even the geographic location of the consumer, e.g., provided via personal location device, GPS of a mobile device, Local Area Network (LAN) device detection, triangulation or other means of location by a telecommunications network of a mobile device, “check-in” at a location via a device or other means, Internet Protocol (IP) address of a device of a consumer, or any other means capable of determining the geographic location of a consumer (whether via his mobile device or not) or a device (mobile or fixed) associated with the consumer.

Once the user is identified, by whatever means may be employed, an advertisement or other promotional information may be tracked all the way to presentment of payment by the user. There are many ways to identify a user. Marketing companies today use technology to identify and target ads to consumers. For example, knowing the consumer's Facebook username can allow an advertisement or other information to be presented to that specific consumer while he is accessing his Facebook page. Likewise, if the user has logged in to another site or application using his Facebook information, promotional information may still be presented to the user at the secondary site once he is identified using his Facebook information. Similarly, knowing the consumer's interactive TV account (e.g., television service provider), and even based on which family member is watching the TV, may allow a targeted advertisement to be presented to the consumer while he is watching a particular program. In yet other embodiments, knowing the consumer's geographic location, such as at a sporting event, can be used to present promotional information to that consumer (whether individually or in collection with the other consumers in the stadium). Still further, a consumer passing a billboard or other display means may be identified, such as with retinal or facial recognition scan, and thus can also be targeted with promotional information at that detected location. Thus, while any means to provide an advertisement or other promotional information to a consumer may be used, the disclosed principles provide for tracking that the advertisement or information was in fact presented to the identified consumer, as well as when, where, and how it was presented, using the consumer identifier to confirm the consumer's identity, location, and/or other information. Moreover, such advertisement or promotional information may be provided by a system implementing the disclosed principles (e.g., operating as a matching agent on behalf of merchants/advertising companies), or it may be provided by an external/third party entity working with the disclosed system, such as an advertising merchant of goods or services advertising for itself, or a third-party advertising entity on behalf of a merchant, in order to track that presented promotional information.

In addition to identifying consumers to target promotional information towards, as well as tracking or logging when, where, and how that information was presented to the identified consumer, the disclosed principles further provide for tracking the consumer's purchasing actions after being presented the advertisement or promotional information. Such actions by the consumer may be immediate upon presentation of the promotional information or long after its presentation, even after the consumer has left the location of the presentation. For this, a system or method as disclosed herein includes registering an account, such as a payment vehicle, that is specifically associated with the targeted consumer. For example, a consumer's credit or debit card, PayPal® account, mobile payment device or application, checking account, or even his utility (e.g., TV provider or phone provider) account information may be registered with the disclosed system or method. Moreover, the registering of the account can be prior to identifying the consumer for presentation of the promotional information, or it can be at the time of, such as in response to, the presentation of the promotional information. Thus, when a consumer employs his one or more registered accounts by interacting in a transaction, financial or non-financial, that is in response to the displayed promotional information, the disclosed principles employ the time and manner of that use to track the consumer's spending or other actions in relation to the presented advertisement or promotional information. Thus, stated generally, the disclosed principles provide for identifying consumers having a registered account, registered prior to or at the time of the identifying, presenting promotional information to the identified consumer, logging the details of that targeted presentation, and then tracking the consumer's use of the registered account in relation to the presented information, whether a financial or non-financial. Accordingly, by combining a registered account of the consumer along with tracking of an advertisement or other promotional information being specifically presented to that consumer, the disclosed principles provide the ability to track and match the provided promotional information with the consumer's actions afterwards using the registered account in order to evaluate the effectiveness of the provided advertisement or information on the consumer.

Furthermore, as noted above, the actions of a consumer in relation to the presented advertisement or promotional information is not limited to financial transactions. Thus, although many of the embodiments illustrated and discussed herein relate to consumer credit card transactions in response to a promotional offer, and thus the matching, tracking, and evaluating the effectiveness of the promotional information using the consumer's financial transaction(s) with a registered account, the disclosed principles also include non-financial transactions. For example, when a consumer, identified via a known/registered identifying account or other identifier, is presented a promotion, such as via an on-screen website banner advertisement, related to a particular event at a given location, the how, when, and where the “impression” of the promotion can be tracked using, for example, the user's registered account (e.g., his Internet service provider (ISP) account or his television provider account with an Internet capable TV). When the user then visits that event at the specified location, a system or method in accordance with the disclosed principles provides the ability to track and match the consumer's response to that presented promotion even though no financial transaction was involved. In this non-financial example, such tracking includes determining when, where, and how the consumer followed the promotion, for example, tracked using his registered GPS (via his mobile device) or even facial recognition or other identifying technology at the location. Thus, the tracking of the initial impression, as well as the tracking of the user's response to that impression, may be logged and evaluated to automatically determine the effectiveness of the promotion on the targeted consumer, all without requiring the user to “click through” the promotion displayed or enter a code or other information associated with that displayed promotion, or even for the consumer to make a purchase, in order to track that the consumer's action was in response to the presented promotion.

The following example helps to explain one specific implementation of the disclosed principles: Consumer A is a member of Facebook®. He has a credit card registered with Facebook and has granted Facebook permission to track his purchase activity as well as deliver offers and discounts that can be tracked with his credit card. He has also given permission to allow a Facebook cookie to be placed on his computer, tablet, and mobile phone to track advertisements delivered to him. The advertiser is Restaurant A. Consumer A need not be a member of Restaurant A's Reward Program. Restaurant A works with ABC Marketing, which generates advertisements for Restaurant A and also tracks Restaurant A credit card purchases. ABC Marketing buys banner ads for Restaurant A from Facebook that can track Facebook member purchases (“payment tracking banner ad”) at Restaurant A (as well as other merchants). Facebook delivers a payment tracking banner ad (this ad could be in Facebook, easily tracked by Consumer A's account, or by a banner ad outside of Facebook, tracked with a cookie) to Consumer A's computer. This ad could be simply to promote the restaurant's onion rings or suggesting that he come in and enjoy a 20% dining discount at Restaurant A. Facebook may deliver messages to Consumer A's tablet or phone as well. Consumer A does not need to click or otherwise “clip” this or any other advertisement. It is simply presented to him. After the advertisement is presented to Consumer A, he goes to Restaurant A and uses the same credit card he has on file with Facebook. ABC Marketing at a designated time period, say one month, delivers a report of all the credit/debit card payments to a Clearinghouse. These credit card numbers are converted to tokens for security reasons. This Clearinghouse also has access to payment tracking banner advertisements distributed by Facebook, to Facebook members. Facebook has data for all payment tracking banner advertisements delivered to Facebook members. Facebook has tokenized the credit card data for security purposes as well. Facebook and ABC Marketing use a tokenization process that allows the Clearinghouse to match the Facebook payment tokens with the payment tokens from ABC Marketing showing purchases at Restaurant A. A report is then prepared for Restaurant A, Facebook, and ABC Marketing (the report may even be anonymous, if desired, to protect consumer privacy) showing Facebook advertisements that may have influenced Consumer A's trip to Restaurant A as evidenced by coinciding purchase behavior at Restaurant A. These reports help all parties value the efficacy of the marketing due to the fact that it is linked with purchase behavior.

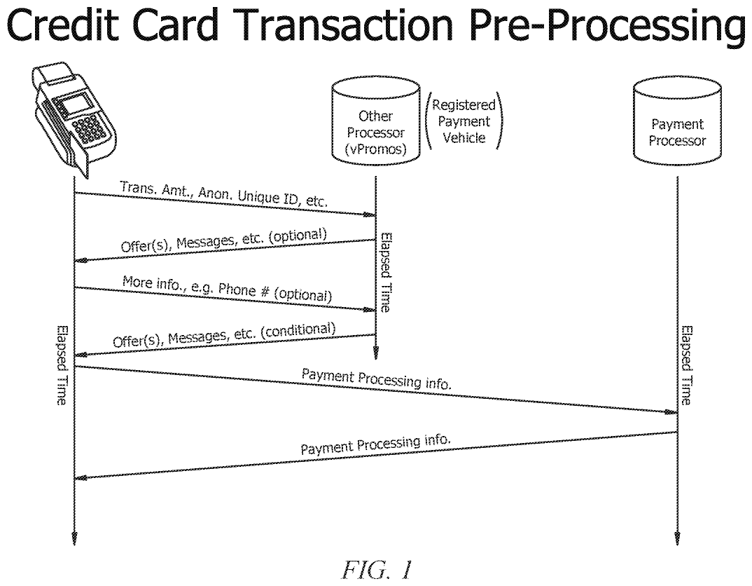

With an understanding of the broad scope of the disclosed principles in mind, exemplary embodiments of implementing these innovative principles in a financial transaction are discussed below. FIG. 1 illustrates a diagram of one embodiment of Credit Card Transaction Pre-Processing that may be implemented with a system or method in accordance with the disclosed principles. Specifically, the disclosed principles include a “pre-processing” step at the time of payment by a consumer using a credit card or other payment vehicle registered with a system or method implemented in accordance with the disclosed principles. Such pre-processing step may be employed as disclosed herein to identify a consumer conducting a credit card transaction via the credit card he previously (or at the time of the transaction) registered with a system as disclosed herein. Such identifying of the payment vehicle and consumer allows the disclosed principles to automatically track the spending behavior of the consumer, and whether that transaction is related to an advertisement or other promotional information previously sent to the consumer.

As illustrated in FIG. 1, the system receives a message from a payment terminal containing transaction information, such as transaction amount, transaction time, and merchant/transaction location, as well as an anonymous unique identifier, such as an alphanumeric code associated with the payment vehicle account number. The disclosed system then processes the information about the transaction and/or user. For example, the system may check if the unique identifier identifies an existing user or someone that will be new to the disclosed system. Thus, individually tailored information may be returned to the payment terminal, such as a discount or to indicate the transaction will be logged against a loyalty program for which the credit card or other payment vehicle is stored (e.g., a “vPunch” provided in the vPromos technology discussed above), or some other message, such as an invitation to join a loyalty program or visit a website. In such embodiments, the tracked promotional information presented to the consumer and the user's response to the promotion is actually presented via this transaction, and thus the tracked actions of the consumer will not be by a later action of the consumer.

Additionally, the message from the payment terminal to the disclosed system need not be direct. For example, the payment terminal may send a pre-processing message to a system owned or operated by the owner of the payment terminal, or the manufacturer of the payment terminal, or any third party, which could then forward a second message to the disclosed system. The disclosed system may then send a message back to the payment terminal, which may be directly to the payment terminal, or may be indirectly through the same system(s) that transmitted the message to the disclosed system or indirectly via some other third-party system. Such differences in routing have no bearing on the fact that a message is provided to the disclosed system as a pre-processing step before transmitting the transaction information to the payment processor, as shown in FIG. 1. Moreover, in the above-discussed vPromos technology there is the ability to include optional messaging back and forth between the payment terminal and the vPromos system in order to gather more information from either the merchant or consumer involved in the transaction. Such technology may also be employed with the disclosed principles.

In order to provide a discount or other incentive during a payment transaction between a user and a goods/service provider, a message may be sent to a system in accordance with the vPromos technology discussed above as a pre-processing step (i.e., within the process illustrated in FIG. 1), which may then be used to provide a discount on the transaction amount prior to clearing the transaction with the payment processing system. Thus, as discussed above, the disclosed principles may use such pre-processing messaging to both identify and track a consumer's spending actions in response to previously presented promotional information, as well as to actually provide the initial promotional information in the first place. Stated another way, rather than only employing the vPromos technology to present and/or redeem offers for registered consumers using a registered payment system at a participating merchant, the disclosed principles can implement the vPromos technology to track consumer response to an offer, no matter when or how it was delivered, that is completely unrelated to a vPromos loyalty program.

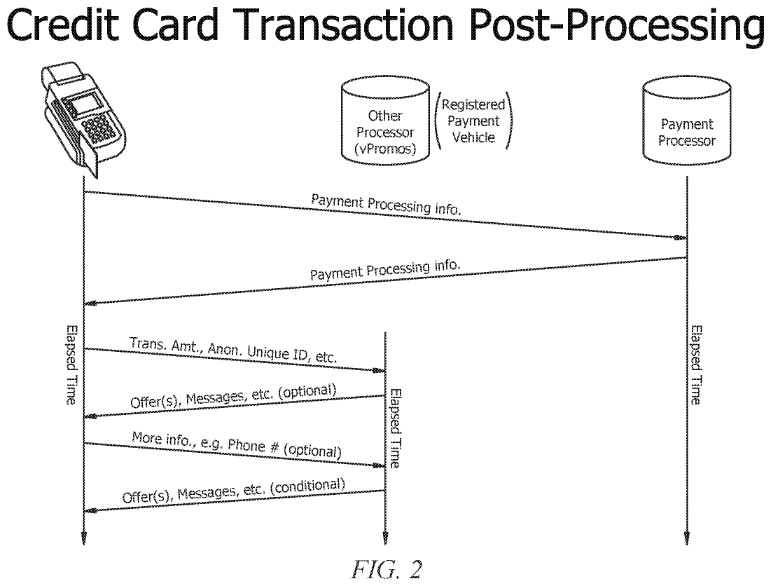

In alternative embodiments, the disclosed principles may also provide that the payment terminal submits transaction information as a post-processing step; that is, after the transaction was processed by the payment processing system. FIG. 2 illustrates a diagram of one embodiment of Credit Card Transaction Post-Processing that may be implemented with a system or method in accordance with the disclosed principles. The exemplary process illustrated in FIG. 2 may follow from the end of the process illustrated in FIG. 1. As before, the disclosed principles may also use such post-processing messaging to both identify and track a consumer's spending actions, using a registered payment system, in response to previously presented promotional information, or to actually provide the initial promotional information to the consumer in the first place. Importantly, however, with the disclosed principles the promotional information, and the consumer's response to that promotional information, does not need to be related to a vPromos loyalty program even though technology similar to that used with a vPromos loyalty program is employed to track consumer response to a prior presented promotion, or to track the actual presentation of a promotion to a consumer so that the consumer may respond to that traceable promotion at a later time using another traceable registered identifying means. Furthermore, in the vPromos technology, there is the ability to include optional messaging back and forth between the payment terminal and the vPromos system in order to gather more information from either the merchant or consumer involved in the transaction.

FIG. 2a illustrates a flowchart presenting an exemplary embodiment of a method for user data collection and presentation in accordance with the disclosed principles. As generally seen in the flowchart of FIG. 2a (200), the exemplary user data collection method may be generally described in terms of the following steps:

(1) Performing a user transaction at a transaction terminal (200);
A user may perform a purchase of goods or services at a location and use a payment terminal for payment.

(2) Sending information of the user to a registered payment vehicle (201);
The information of the user and the transaction, which includes a registered or to-be-registered payment vehicle, may be sent to an information tracking agent. The user information may include an anonymous unique identifier, such as an alphanumeric code associated with the payment vehicle account number and the transaction information may include information, such as transaction amount, transaction time, and merchant/transaction location.

(3) Updating information of the user in a database (202);
The information tracking agent updates the user and transaction information in a database that is accessible by the information tracking agent directly or via a network.

(4) Checking if the user exists in the database, if so, proceeding to step (206) (204);
The information tracking agent may check the existing database with the unique user identifier and determines if the user is an existing user.

(5) Registering the user and adding the user to the database (205); and
If the user is new, the user may register with information tracking agent for future transactions and tracking. This may include storing information regarding a registered payment vehicle of the user that may be used to purchase items or services that are the subject of an advertisement to be presented to the user.

(6) Tracking the user for presenting future advertisements (206).

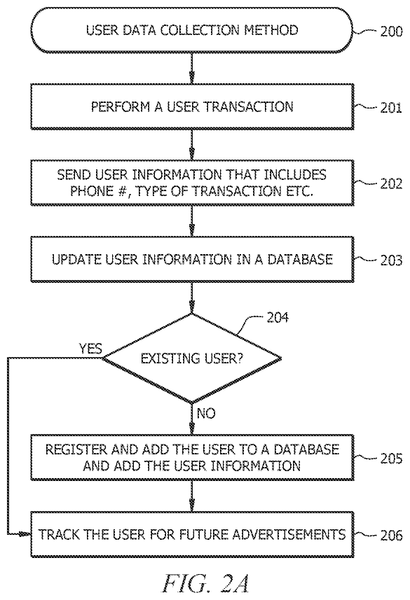

FIG. 3 illustrates a diagram of one embodiment of Credit Card Transaction Logging, such as by the vPromos technology, but that may be implemented with a system or method in accordance with the disclosed principles. For a system or process according to the disclosed principles, the implementation need not include such optional back and forth messaging, and instead the disclosed system could simply receive messages to create a history of transactions, noted as “simple logging” in FIG. 3. Simple logging could be performed either as a pre-processing, post-processing, or parallel processing step, and would be implemented to log the presentation of a promotion to a traceable user, or alternatively to log the response of a traceable user to a previously logged promotion presented to him. Although the information transmitted back and forth is referred to herein as “messages,” in many network protocols receiving a message includes various transmissions at lower “layers” of the network protocol to ensure reliable transmission in the sense that the message is both received and is also free of errors possibly introduced during transmission. Such lower layer communications in order to create reliable message transmission may or may not be used and both possibilities are assumed to be a design choice in implementing a system in accordance with the disclosed principles.

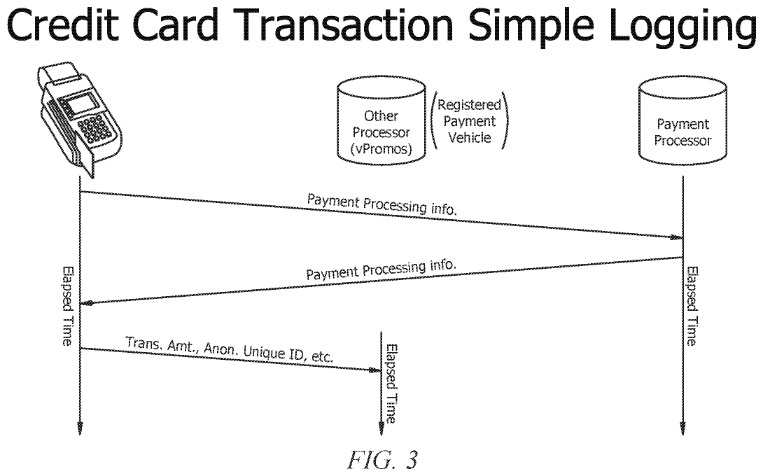

Any of the above-discussed processes, or even combinations thereof, may be used to create a history of credit card transactions in embodiments where credit card transactions are used to track the consumer's spending in response to receiving promotional information. FIG. 4 illustrates a diagram of one embodiment of a Consumer Response Transaction Log that may be implemented with a system or method in accordance with the disclosed principles. A similar log may also be present that logs the initial presentation of the promotion that the user is responding to, as discussed in further detail below. In the illustrated embodiment, the consumer response transaction log includes consumer response data, such as a type of consumer transaction in response to a presented promotion, along with transaction time, transaction location, and transaction amount, and any unique identifiers (i.e., associated with the consumer, the consumer's account(s), the transaction, the merchant, the promotional information, etc.). In addition, the registered payment means by which the consumer's response to the promotional information is logged as a purchase transaction to allow the disclosed system to automatically track the consumer's response to the promotion, and thus the efficacy of promotions, as disclosed herein. Although FIG. 4 illustrates a response tracking log for a credit card-based financial transaction, such a log may be modified to reflect consumer responses in non-financial transactions as well, such as the examples discussed above.

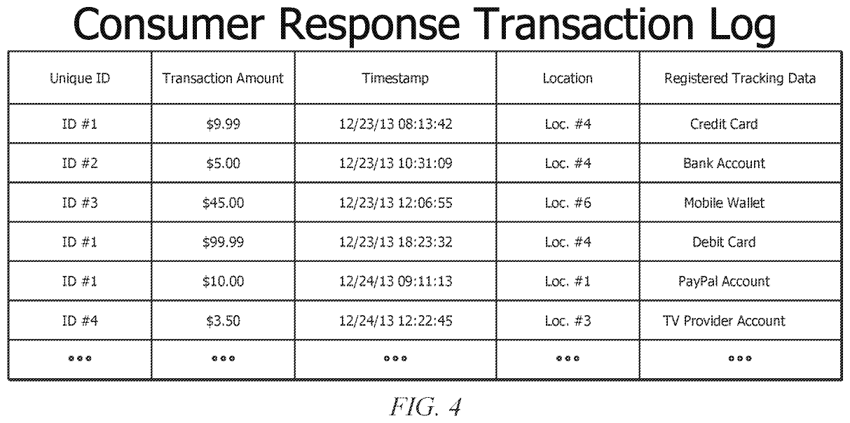

As mentioned above, the disclosed system may implement technology similar to the vPromos technology, which enables sending messages back to the payment terminal, among other features. Moreover, such messages may be printed on the screen of the payment terminal, prompting the merchant to enter more information immediately or to solicit more information from the consumer, such as registering the consumer and perhaps even the used credit card with the disclosed system, and enter that information via the payment terminal. Still further, it is also possible to print information beyond what might otherwise appear on the consumer's receipt, where the additional information is provided by a system or method according to the disclosed principles to the payment terminal. Thus, looking at FIG. 5, illustrated is a diagram of one example of Receipt Messaging that may be implemented with a system or method in accordance with the disclosed principles. As shown in FIG. 5, the ability to provide messages on a customer's receipt allows users (e.g., advertisers, merchants, etc.) of the disclosed system to inform users of loyalty status, discount applied, or any present other information desired. However, the disclosed principles may now employ such messaging to provide an advertisement or other promotional information in accordance with the disclosed principles in the form of messages on the receipt for the consumer to visit a website, a social media page, download an application, etc., where that presented advertisement is not actually related to a vPromos loyalty program. Moreover, although a printed receipt is shown in this example, the same technique of the disclosed principles may also be implemented with emailed receipts instead of paper receipts. In any case, the disclosed principles extend the use of receipt messaging, whether with a vPromos loyalty program or not, to be used as a means for universally presenting promotional information to a consumer, while the payment terminal employed to track the presenting of that promotion to the consumer.

In the illustrated embodiment, since the consumer is a member of a vPromo loyalty program, the promotional message on the receipt offers the consumer an additional vPunch by simply visiting the merchant's Facebook page using his own registered Facebook account, and “Liking” the merchant. Since the consumer's Facebook information is registered with the disclosed system, the consumer's response to the promotion on the receipt is automatically tracked without the need for the consumer to enter a special code or any other additional action. For instance, additional action tracking might require the loyalty member to log onto the loyalty application or site, and then click a hyperlink from within the loyalty site or application, to allow for the tracking of the “Like” in this example. On the second illustrated receipt, the consumer need only visit the physical location of the merchant, and using a registered identifying means, such as GPS or even facial recognition technology, the consumer's visit to the location is traceable as a response to the presented promotion. In both examples, the payment terminal is employed to track the presenting of the promotion to the consumer (i.e., via the receipt, whether paper or emailed), and the consumer's “like” of the merchant's page or visit to the merchant's location is tracked as a response to the promotional offer on the receipt. Therefore, by providing a promotional message to a consumer with a registered account or other identifying information, and then determining if, when, where, and how the consumer follows that message using a registered account or other registered identifying information, the disclosed principles allows users of the vPromos technology, such as merchants, advertisers, and advertisement providers, to track the efficacy of the message provided to the consumer even when it is not related to a vPromos or other loyalty program.

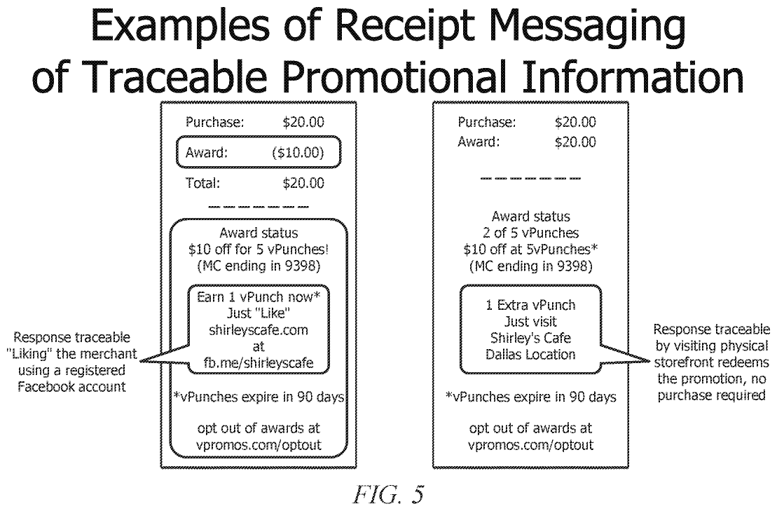

Turning to FIG. 6, illustrated is a diagram of one embodiment of Receipt Message Tracking that may be implemented with a system or method in accordance with the disclosed principles. By providing consumers who have a payment vehicle or account registered with, or are prompted to register with, a system as disclosed herein, messages associated with a transaction of such consumers, such as a receipt from a financial transaction, can provide promotional information to a consumer that is identified by his payment vehicle or account.

Looking at the example in FIG. 6, an exemplary embodiment is provided where a consumer follows the instructions of a message on his purchase receipt, such a receipt illustrated in FIG. 5, which leads him to visit the Facebook page of the advertising merchant and “like” that page in accordance with the promotion on the receipt. Such a system initially tracks the providing of the promotion to the consumer via the receipt, such as the time, date, location, amount, and payment vehicle used for the purchase transaction. In this example, the consumer already has an account with the disclosed system, and the consumer may thus be identified when using the registered payment vehicle for the initial transaction. When the promotion is provided to the consumer via the receipt, the providing of that promotion is logged so that a traceable response to the promotion by the consumer may also be automatically tracked with the disclosed system. As illustrated, the consumer responds to the presented promotion by visiting the advertising merchant's Facebook page (illustrated with HTTP request/reply), and then “likes” their Facebook page (also illustrated with HTTP request/reply). That interaction by the consumer responding to the promotion presented to him on the receipt is traceable by the disclosed system because the consumer's Facebook account information is registered with the disclosed system. Accordingly, in this example, one set of identifying information (i.e., the consumer's registered payment card) is used to track that the promotion was in fact presented to the consumer, and a separate set of identifying information (i.e., the consumer's registered Facebook account information) is used to trace that the consumer did in fact respond to the promotion. Therefore, the disclosed principles provide for automatically tracking, i.e., without additional action(s) required on the part of the consumer, consumer response to the promotions so that the effectiveness of the means of presenting the promotional information can be determined.

Moreover, although the example set forth in FIG. 6 illustrates distinct domains for the specified website that receives the consumer's response and the system tracking the consumer's response to the promotion, the two may be provided in a single system. However, in those embodiments where distinct domains or systems are employed, the disclosed principles may still provide for privacy to be maintained with regard to consumers' accounts and the advertisement tracking. In such embodiments, identifiers shared between the consumer's access device (e.g., computer or mobile device) and Domain #1 may be kept confidential between the consumer device and the server(s) on Domain #1. Similarly, identifiers shared between the consumer device and Domain #2 may be kept confidential between the consumer device and the server(s) on Domain #2. Such isolation of confidential information may be important to some participants of the disclosed principles, such as consumers who hope to keep their financial account information out of the hands of advertisers. However, since such consumers have already registered their account(s) or other identifying information with a system according to the disclosed principles, those consumers' confidential information may continue to be protected by this system. However, in other embodiments, it is also possible to synchronize some or all information between the systems of Domain #1 and Domain #2, if desired, and techniques for accomplishing such synchronization are known to Internet-based advertising service providers.

It should be understood that in the context of the disclosed principles, the term “transaction” as used herein is not limited to just financial transactions, such as the credit card examples discussed above. Instead, the term “transaction” is used broadly herein to include any interaction a consumer may have with another party or entity and which is conducted using a means that is automatically traceable by the disclosed system or method. For example, rather than a financial transaction with a merchant the consumer visited, a transaction herein may relate to non-financial actions of a consumer, such as simply visiting a specific website using a registered ISP account, calling or texting a specific number using a registered telephone number or telephone service provider account number, visiting or “liking” a specific site using a registered Facebook® or other type of social media account, physically visiting a specific location using a registered GPS device or other traceable interaction identifying the consumer, each of which was facilitated by information provided in the promotional information presented to the consumer, and acted upon by the consumer using a registered account or other traceable information. Accordingly, the disclosed principles go far beyond simple credit card transactions with consumers having credit cards registered with the tracking network, and instead extends to automatically tracking the effectiveness of promotional information presented to the consumer, without additional consumer actions, by identifying the consumer using any type of payment vehicle, account, geolocation tracking, or even biometric identification information the user may have when the promotion is presented, as well as when the consumer simply provides an interaction related or in response to that promotion using a registered account or other identifying information.

In addition, the disclosed principles broadly provide a means for presenting such promotional information to a consumer, where the promotion is related to an advertiser or merchant, and the consumer's response to that message by using nothing more than a registered account or other traceable information. Therefore, in addition to the receipt message printing discussed above, the disclosed principles also provide for presenting the information to the consumer through viewing a billboard, a website, a television presentation, or even a newspaper or magazine.

In embodiments employing online promotions, a website may be used to display promotional information, e.g., via banner advertisement. If the consumer's ISP account is registered with the disclosed system, the display of the banner advertisement to the consumer can be documented when the consumer is using that registered ISP account to visit the website. Then, without requiring the consumer to click the banner ad in order to track its effectiveness, the consumer may simply navigate to a website promoted on the banner ad, again using his registered ISP account, and the disclosed system can automatically track the consumer's action in response to the banner ad. Similarly, the banner ad may display information regarding a physical location. In such embodiments, the consumer's navigation to that physical location, using registered information related to a GPS device of the consumer, can automatically be tracked to determine that he visited the physical location in response to the online promotion. Alternatively, rather than tracking registered GPS information, the consumer may use a registered payment system at the location, or even make a phone call to the physical location using a registered telephone number or account, and the disclosed system can still automatically track the consumer's response to the promotion.

In embodiments employing offline promotions, for example, promotional information provided via a billboard, that billboard may be a typical billboard on the side of a road. In such embodiments, the consumer may have registered an account or other information related to GPS information associated with the consumer, such as his mobile telephone information. In other embodiments, the billboard may be provided at location having a collection of potential consumers, such as a sports stadium or similar venue having a large collection of people. The presence of those people may be confirmed again using registered GPS based information, or even the LAN WiFi network are the stadium when the consumers' mobile device is registered with the disclosed system. Regardless of the location or the number of potential consumers, the disclosed system determines that a consumer was in fact present at the billboard, and thus the information on the billboard was presented to that consumer. Then, if the consumer uses a registered account or other registered identifying information to act on the information displayed on the billboard, the disclosed principles can automatically track that action in response to the billboard using the consumer's registered account/information, and without requiring the consumer to conduct any other action(s).

In a related embodiment, the billboard may be a billboard with facial or retina recognition capabilities. If the consumer's facial or retinal information is registered with the disclosed system, the presence of the consumer in front of the billboard can be logged, and then if the consumer uses a registered account or other identifying information to act on the information displayed on the billboard, the disclosed principles can automatically track that action in response to the billboard using the consumer's registered account/information, again without requiring the consumer to conduct any other action(s). Moreover, the billboard may also be a virtual billboard with similar recognition capabilities, and thus once the consumer is identified by the disclosed system, the actual promotional information displayed to the consumer may be customized just for him or her.

In an offline example using individual print media, such as a newspaper or magazine, the promotional information may be provided to a specific consumer via a periodical to which he has subscribed. Thus, the disclosed system can confirm that the promotion was presented to that specific consumer when the consumer's subscription information is registered with the disclosed system. Then, when the consumer follows the information in the promotion, again using a means of interaction that is registered with the disclosed system, the actions of the consumer based on the promotional information may be automatically tracked and matched as a response to the promotion in the registered periodical, and thus the effectiveness of the printed promotion may be evaluated without further action by the consumer.

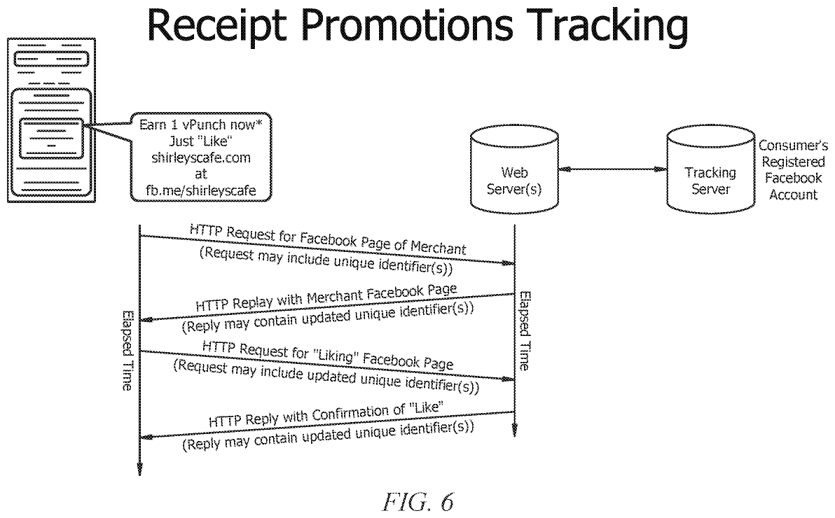

Referring now to FIG. 7, illustrated is a diagram of one embodiment of a Promotional Information Presenting and Response Tracking Log for an exemplary consumer that may be implemented with a system or method in accordance with the disclosed principles. The purpose of the tracking log is to create a list of events that are each uniquely associated with the presentation of a promotion to an individual, as well as an individual transaction for a given payment vehicle or other registered account or identifier of a consumer used in response to the promotion. Such a tracking log may then be used to determine and evaluate various details of the initial presenting of the promotional information to the consumer, in combination with the consumer's subsequent interaction in response to the presented promotional information, such that information on the effectiveness of the advertisement, promotion or other information can be evaluated in accordance with the disclosed principles.

Multiple methods of interacting from the consumer's registered accounts or other identifiers may be used simultaneously, as shown by the various response exemplary tracking events in the sample log of FIG. 7. As illustrated, such a log may contain any information advantageous in the automatic tracking and evaluation provided by the disclosed principles. For example, not only are the date and time stamps for the consumer's response to promotional information logged, but the registered means by which the consumer responded is also logged, as well as the merchant advertiser, the type of media used to present the promotional information to the consumer, the actual promotion or offer, how and when the consumer's response was tracked, and any unique identifier associated with the interaction, promotion, or transaction. Of course, other or additional information may also be used to track the promotional information displayed to consumers, as well as the means by which the consumers may respond to those promotions.

Regardless of the specific tracking information regarding both the presenting of the promotional information and the consumer's reaction to that information, a tracking log as disclosed in FIG. 7 may be used by merchants or advertising/marketing agencies to determine the effectiveness of various types of advertising. For example, a marketing campaign may be created that presents promotions using various means for presenting the promotions. Examples could include banner ads on certain websites or associated with certain mobile applications, physical billboards along heavily travelled routes as well as at specific sporting stadiums, email distributions, TV advertisements via iTV or standard TV, promotions printed on transaction receipts, and even print media (e.g., magazines and newspapers). Then, using a system or method according to the disclosed principles, the effectiveness of those various means of presenting promotions to certain consumers may be tracked, for example, over a 30 day period. During that evaluation period, the actions of the targeted consumers in relation to advertised products or services, depending on the promotion, are also tracked, where possible. For example, as illustrated, the GPS location of a consumer at an advertised location, a consumer's purchase of an advertised product or at an advertised location, or even the consumer's online behavior related to an advertised site, could all be traced with the system or method of the disclosed principles using various registered means of identifying the consumer. At the end of the exemplary 30 day period, the consumer's responses to the various means of presenting him promotions can be evaluated to determine which type and means of presenting the consumer promotional material was most effective, and even which were not effective at all. Additionally, tracking demographic data could also provide information on the effectiveness of various delivery methods used to present promotional information to each demographic category evaluated. In short, the disclosed principles provide an automatic and effective means of evaluating the effectiveness of not only certain types of promotions in general, but also the means by which those promotions are presented to various categories of consumers.

Some of these promotions may or may not have been seen by the consumer. For instance, GPS location coupled with a billboard may have a different (e.g., lesser) certainty of impression when compared with an email delivered, opened, and clicked by the consumer. In this instance, the different type of advertisement may be given an “Impression Probability Rating.” In another example, a brand may deliver an advertisement for Chili's® restaurant during a particular television program. The consumer in this example is married with two kids, a boy 8 years old and a girl 16 years old. The consumer agreed with his cable operator that it can track his payment system at certain merchants. The consumer's payment system is used to make a purchase at Chili's three days after the advertisement is presented. How likely is it that the Consumer made this purchase? Or his wife or his daughter? Now compare this example with an interactive TV example, in which the TV at the time of launch is configured to ask which consumer is watching the TV: the father, mother, son or daughter. If he selects “Father,” then a different advertisement may be delivered to the father based upon his demographics. In this case, the ad could be for Home Depot®. The father's payment system is used to make a purchase at Home Depot three days after the advertisement is presented to the father. Because there is more data available in the second example, i.e., that the father was watching the targeted ad, the degree of likelihood that the father actually saw the advertisement is higher than in the first example. In the first example, there is a one out of four chance that the father saw the advertisement if there was only one person watching. While that percentage may go down based on the demographics of the program having the advertisement, i.e., who the program is geared towards, tracking the efficacy of this Chili's advertisement still has less certainty than the Home Depot advertisement.

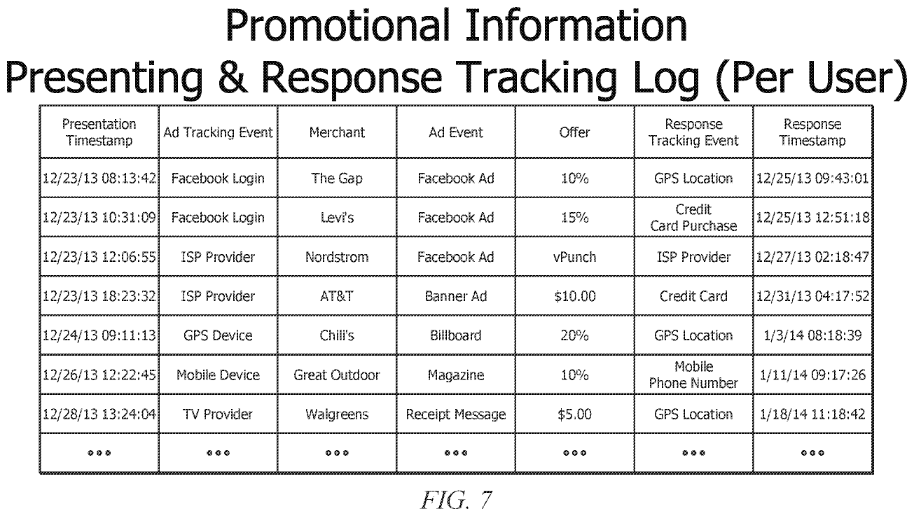

FIG. 8 illustrates a diagram of one embodiment of Credit Card Transaction Matching that may be implemented with a system or method in accordance with the disclosed principles. With such transaction matching, which as discussed above extends far beyond mere credit card or other financial transactions, the various methods and processes disclosed herein may be cross-referenced to evaluate the efficacy of the advertisement or other promotional information presented to the consumer, as well as the efficacy of the means by which those promotions are presented. This is done by matching the records associated with promotional information sent or otherwise displayed to a consumer, with the records associated with the consumer's response to the promotional information using a registered account or other identifying means.

Illustrated in FIG. 8 are exemplary pieces of data or other information that may be used for the disclosed transaction matching from the records in such transaction logs. For example, for matching credit card transactions, individual transactions may be captured as a “Single Credit Card Transaction Record,” along with consumer presentation and response tracking for consumer transactions in response to promotional information in a “Presentation and Response Tracking Record,” both shown in FIG. 8. In addition to such exemplary transaction records, the disclosed principles for matching and tracking the display and response to promotional information may also aggregate information from many other useful sources. Such sources may include data from ad-tracking servers associated with advertisements being presented and tracked with the disclosed system. Such ad-tracking data may be used to create an “Ad Serving Log,” as illustrated. Such logs of advertisements may include unique identifiers for devices and users, as well as the means by which the advertisements were displayed or otherwise provided to the consumer(s). In all the records illustrated in FIG. 8, additional or alternative information for automatically tracking consumer response to promotional information may also be included.

In related embodiments, the captured data may include a unique product identifier for each specific product or item, or even a service, purchased during the consumer's transaction at or with a merchant or other type of provider of goods/service. Such a unique product identifier may be a SKU (Stock Keeping Unit) number or code, which is an alphanumeric code that identifies a product and helps a merchant or other interested entity track inventory, or it may be the Universal Product Code (UPC) of a product or item, which is typically a barcode symbol uniquely identifying a product. Any other type of unique product/service identifier, either now existing or later developed, may also be used to track specific consumer purchases or other types of non-purchase transactions. SKU numbers can be created manually or may be created by inventory management or point-of-sale software (e.g., in the cash register), while UPC codes are typically generated by the manufacturer or packager of the product. As discussed above, the disclosed principles provide for tracking a targeted consumer's actions in relation to products or services that are the subject of an advertisement presented to the consumer, including tracking the purchase of an advertised product to determine the efficacy of the advertisement advertising that product/service. Thus, one specific technique used by a system or method according to the disclosed principles to track the purchase of an advertised product may be the capturing of the product SKU number (or UPC code, QR code, or other unique product identifier) with the POS system (cash register), and then transmitting that SKU number to the disclosed system or an affiliate of the disclosed system by the payment terminal for use in the matching and tracking disclosed herein to determining the efficacy of the advertisement associated with the product. In such embodiments, the matching agent's system, or other entity within or affiliated with a system as disclosed herein, may be provided the SKU number(s) of those products that will be the subject of an advertisement to be tracked, and then the captured and transmitted SKU number(s) during the consumer's transaction at a merchant, in person or online, are matched using the disclosed principles to assist in determining the effectiveness of the advertisement of the product(s). Of course, the captured SKU numbers or UPC codes (of other unique identifier) may also be used for determining other things, such as simply gathering data on what items certain consumers are purchasing, whether related to presented advertisements or not.

One specific example implementing the SKU numbers of advertised products could be employed with the presenting of advertisements via interactive TV, as discussed above. For example, a Hulu® consumer could be watching TV through his Hulu account. If the Hulu subscription is shared, within the family for example, this Hulu customer could self-identify while watching the streaming TV service such as by selecting his profile when beginning viewing. This Hulu customer has his payment credit card or other payment credentials/vehicle/system on file with Hulu for recurring monthly payments for the Hulu subscription. Further, this customer has agreed to terms and conditions allowing Hulu and its partners to track his payment activity with that payment vehicle online and offline through advertising partners. When the Hulu platform presents an advertisement from an advertising partner to the viewing consumer, Hulu would track that the product/service was advertised to the particular viewer, as well as the date and time of that presentation, and then that information, along with the security token of his payment credential(s), is provided to the disclosed system or a system affiliated with the disclosed system. Then, if the viewer visits a merchant participating with the disclosed system and purchases the advertised product/service, that data is also shared with the disclosed system, for example, using the SKU data of the purchased item. The disclosed system knows that the Hulu subscriber shopped at that merchant because of the payment credentials from Hulu that have also been used for the purchase (or perhaps a different payment system still having the subscriber's information for tracking the identity of the subscriber). The efficacy of the Hulu advertising for the particular product/service presented while viewing his Hulu account can be determined because the POS register at the merchant will capture the SKU number (or other identifying code) of the product, and the payment terminal, in addition to being used in its normal function for authorizing payments, can be configured via software as disclosed herein to transmit the SKU number and other data as discussed above, to the disclosed system in accordance with the principles discussed herein. When the disclosed system receives the advertisement data and other related information provided from Hulu and the information provided by the specially configured payment terminal, the SKU number data may be used to determine that the product purchased was the subject of the presented advertisement, and the payment system information may be used to identify the consumer as both the purchaser of the product and the person to whom the advertisement was presented. Then, in accordance with the principles discussed herein, if the product was purchased within a predetermined time from when the advertisement was presented to the consumer, then the purchase may be determined to be likely in response to the advertisement.

Of course, other interactive TV platforms may also be used in this manner, or even simply television service providers such as DirecTV® or Uverse®. Such television service providers employ customer equipment that is typically Internet-connected and thus capable of tracking real-time watching data along with advertisement presentations to their viewers. Such viewing equipment can also be configured with technology to identify specific viewers, such as, for example, the viewer selecting their personal channel guide to automated technology such as eye-tracking/scanning, facial recognition, or other identifying technology. The same is also possible with audio-based providers, such as iTunes®, Pandora® and Spotify®, where such providers know when subscribers are using/listening to their service because of each subscriber's unique account and mobile device, as well as when and for what products advertisements are presented to those subscribers. The disclosed principles may therefore similarly match such use and advertisement tracking data with SKU number capturing at the specially configured point-of-sale as disclosed herein to determine efficacy of those advertisements on those particular subscribers.

In addition to identifying a certain specific product item, SKUs can also be used along with a system or method of the disclosed principles to track purchases of categories as well. Categories can include brands, such as Polo®, Levi's®, Calphalon®, etc. Hence, for example, Hulu may present a generic Polo advertisement promoting the Polo brand in general, but no product in particular. Then, in accordance with the principles disclosed herein, if a Polo-branded product was purchased from a merchant participating in the disclosed system, by the targeted/identified consumer to which the advertisement was presented, and within a predetermined time from when the advertisement was presented to the consumer, then the purchase may be determined to be likely in response to the advertisement. In such embodiments, SKUs or other identifying codes may again be used on the products, which are captured by the POS and/or payment terminal, along with the payment information of the consumer, and transmitted to the disclosed system or an affiliated of the disclosed system for use in identifying the brand purchase by the advertised-to consumer in the manner described herein.

Additionally, the disclosed system can work in the opposite direction for the purpose of targeting offers to, for example, a Hulu subscriber. Because the system would already be in place with merchants and advertisers using the unique system, methods, software and in some cases hardware in accordance with the principles disclosed herein, reversing the process is simple. The participating merchant is already using payment terminals and a POS system with the disclosed system software to alter the typical functioning of these pieces of retail equipment. Moreover, this equipment is already tracking SKU-level data (or other unique, identifying codes) and matching it to a digital publisher's subscriber's payment credentials with a platform capable of delivering advertisements to subscribers, such as Hulu, Facebook, Twitter, etc. Thus, when the Hulu subscriber shops at a merchant that participates in the disclosed system and buys two products, for example, the disclosed system can recognize that a Hulu subscriber is shopping and track that purchase data, and then share that information with the digital publisher, or Hulu in this example.

In a more specific example of this type of implementation of the disclosed principles, the Hulu subscriber at the participating merchant may have purchased a yellow Izod® shirt and green Docker® pants, and the product-identification data, as well as the consumer identifying information (e.g., payment credentials matching those registered with Hulu for subscription payments) would be shared with Hulu, the Hulu advertising logarithm could then take that data and calculate the right targeted advertisements to the Hulu Subscriber based upon his past purchases. For instance, when this particular Hulu subscriber is watching Hulu, Hulu could deliver IZOD product advertisements. The link would then continue such that if the Hulu subscriber presented with this IZOD advertisement shops and pays for additional IZOD products, with his Hulu payment credentials at a merchant participating in the disclosed system, the efficacy of this advertising as well as the Hulu algorithm based upon data collected from the disclosed system would be proven.

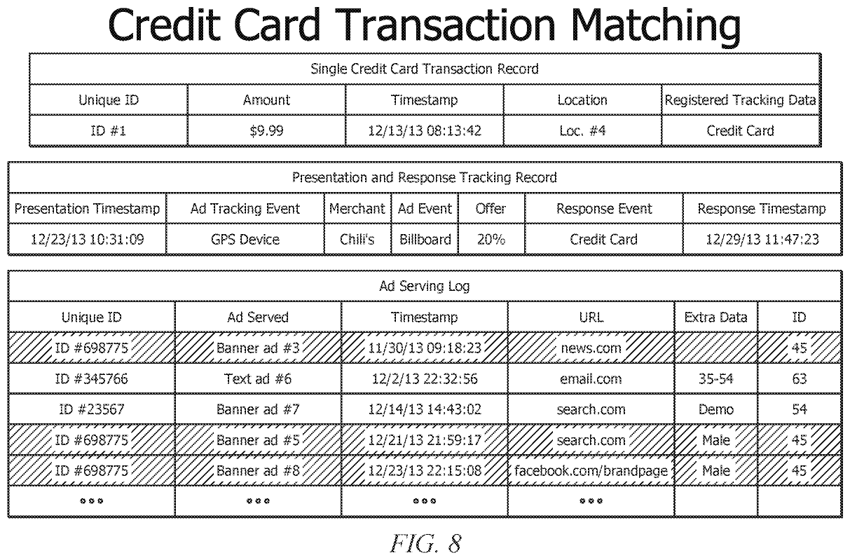

In an exemplary method of matching a credit card transaction from a payment terminal device to an online advertisement in accordance with the disclosed principles, FIG. 9 illustrates one embodiment of a system 900 for the automatic tracking of consumer response to promotional information disclosed herein. Specifically, illustrated is a consumer 905 who has registered a credit card account number, his ISP service provider information, and his mobile device's 907 GPS tracking information with a consumer account information database (“information tracking agent”) 910. In this example, a merchant restaurant 915 seeks to improve business through advertising, and therefore has chosen to conduct an advertising campaign using online banner advertisements. To conduct the campaign, the merchant 915 has hired an advertisement provider 920 to create and distribute the banner advertisements.

Once the advertisement provider 920 has created appropriate banner ads 925 having a specific promotion or offer thereon, those banner ads 925 are distributed on the Internet. When the banner ad 925 is delivered to the consumer's computer 930, an advertisement tracking cookie may also be delivered with the banner ad 925. To view the banner ad 925, the consumer 905 uses his computer 930 to connect to the Internet via his ISP account. Since the consumer's ISP account information has been registered with the database 910, the advertisement provider 920, via the tracking cookie, can determine that banner ad 925 was in fact presented to the consumer 905 while the user was accessing the Internet using the registered ISP information.

After the banner ad 925 is confirmed as being presented to the consumer 905 using a registered account, the disclosed principles then provide for automatically tracking the consumer's response to the banner ad 925 using the same or other registered account or identifying information. For example, when the consumer 905 visits the advertising merchant 915, the consumer 905 may pay for goods or services using the credit card he registered with the database 910 of the disclosed system 900. Alternatively, the consumer 905 may be prompted to register an unregistered payment method he tries to use at the merchant 915. In either case, the credit card is passed through a credit card terminal 935 at the merchant 915 that is associated with the disclosed system. The registered credit card information is transmitted to a matching agent 940, which is tasked with matching the registered credit card data to the banner ad 925. Such transaction information is also sent to the credit card processor 945 for processing of the payment to the merchant 915.

To match the advertisement and the purchase to the same consumer 905, the matching agent 940 obtains information on the banner ad 925 from the advertisement provider 920. Alternatively, the advertisement provider 920 may provide the information regarding the presentation of the banner ad 925 in the database 910, and then the matching agent 940 access the database 910 to determine that the banner ad 925 associated with the merchant 915 was displayed to the consumer 905. Once the matching agent 940 has the necessary information, the matching agent 940 can determine that after being displayed the banner ad 925, the consumer 905 made a purchase at the merchant 915 using the registered credit card. In addition, the matching agent 940 can determine how long it was after the banner ad 925 was presented to the consumer 905 that the consumer 905 made the purchase at the merchant 915. In an alternative embodiment, if the consumer 905 did not use his registered credit card to make the purchase at the merchant 915, the registered GPS information from the consumer's mobile device 907 may also be used by the matching agent 940 to determine that the consumer 905 at least visited the merchant 915 after being presented the banner ad 925. In either embodiment, if the consumer 905 visited the merchant 915 soon after being presented the banner ad 925, the matching agent 940 can reasonably determine that the banner ad 925 was likely effective on the consumer 905. The matching agent 940 keeps such information in an advertisement tracking log, and thus can report the effectiveness of the banner ad 925 to both the advertisement provider 920 and the merchant 915.

Also illustrated in FIG. 9 are other attempts at presenting promotional information to the consumer 905, specifically, a physical billboard 950 having promotional information that targeted to be of interest to the consumer 905. Such a billboard 950 may be provided at a roadside location, for example, a heavily travelled highway, or even a stadium or other location dedicated to sports, business conventions, etc. When the billboard 950 is provided, the specific location of the billboard 950 would be stored by the advertisement provider 920 so that responses to the billboard 950 can also be tracked. In this embodiment, the consumer 905 probably did see the billboard 950 because he drove by it each day on the way to work, and that confirmed impression to the consumer 905 could be verified using the consumer's mobile device 907 GPS, if registered with the disclosed system, or could even by verified using facial recognition technology or other technology configured to identify the consumer 905 at a particular location. In this case, although it was confirmed that the promotional information was presented to the consumer 905, no traceable response of the consumer 905 to the promotional information was detected. This could be because the consumer 905 did not employ a registered (i.e., traceable) means of responding to the promotional information, e.g., he used an unregistered credit card to make a purchase or he did not have his registered mobile device with him when he visited the merchant.

Still further, FIG. 9 illustrates other attempts at presenting promotional information to the consumer 905 in the form of an advertisement to be generated on Facebook pages 955 and an advertisement to be generated on a search results page for a Google® search. For both of these means of presenting promotional information to the consumer 905, the consumer 905 may not have seen either advertisement. For example, perhaps the Consumer 905 has not accessed his Facebook account since the advertisement was created, or perhaps he has not performed a Google search in a long time. In either case, the fact that the promotional information has not been presented to the consumer 905 would be an unconfirmed impression, and thus there would be no consumer 905 response to the promotional information to trace. Of course, the above descriptions are simply examples of confirmed and unconfirmed advertising impressions for the illustrated consumer 905, as well as traceable and untraceable responses to the promotional information by the same consumer 905. Thus, numerous variations of these situations are possible, and each such variation would still fall within the broad scope of the disclosed principles.

Additionally, although the embodiment set forth in FIG. 9 illustrates the advertisement provider 920, the matching agent 940, and the database 910 are separate entities, such separation is not required. Specifically, the matching agent 940 may also maintain the information database 910, and thus work with the advertisement provider 920 to provide and receive such information for the database 910. Alternatively, the advertisement provider 920 may maintain the database 910, and then work with the matching agent 940 to determine the advertisement efficiency. Still further, the advertisement provider 920 may also be the same entity as the matching agent 940, or all three of the matching agent 940, the advertisement provider 920, and the database 910 may be in the same entity. Moreover, additional entities may be employed to administer all or part of the components and processes associated with the disclosed principles, and no limitation to any particular system or process is intended.

Still further, promotional information distributed and tracked as disclosed herein are not limited to a single consumer. Thus, promotional information may be presented to multiple consumers simultaneously, or consumers presented a promotion may elect to “gift” that promotion to another consumer having registered identifying information. A consumer may also “gift” a promotion in a viral manner, such as by posting or distributing the promotion via social media for other registered consumers to enjoy. In such embodiments, the disclosed principles not only automatically track the initial consumer's response to the promotion, but can automatically track other consumers' responses to the promotion, as well as the “gifting” or viral distribution of the promotion itself, for example, if it distributed via a registered account of the original consumer.

By constructing or implementing a system or method in accordance with the disclosed principles, a number of advantages can be realized. Fundamentally, users of the disclosed system or method may automatically track the effectiveness of online or offline promotional information by using consumers' registered identifying information to present the promotional information, as well as using consumers' registered identifying information to automatically track response to presented promotional information without further consumer action. Not only can the efficacy of individual promotions to certain consumers be tracked, but the disclosed principles may also be used to automatically track overall promotion count versus overall consumer response. In addition, any number or type of account or other identifying information, either now existing or later developed, may be registered and used by a system or method as disclosed herein. Importantly, the automatic tracking disclosed herein in not limited to tracking the same registered information as was used to present the promotional information. Moreover, any potential registered means for presenting promotional information to a consumer may alternatively or additionally be used to automatically track the consumer's response to the promotional information. Also, the response to the promotional information by the consumer is not limited to financial transactions, and instead may also encompass the consumer's mere visit to a website or physical storefront in response to a promotion. No matter which embodiment is implemented, the disclosed principles provide for automatic tracking of consumer response to promotional information presented to those consumers not previously possible with conventional technology.

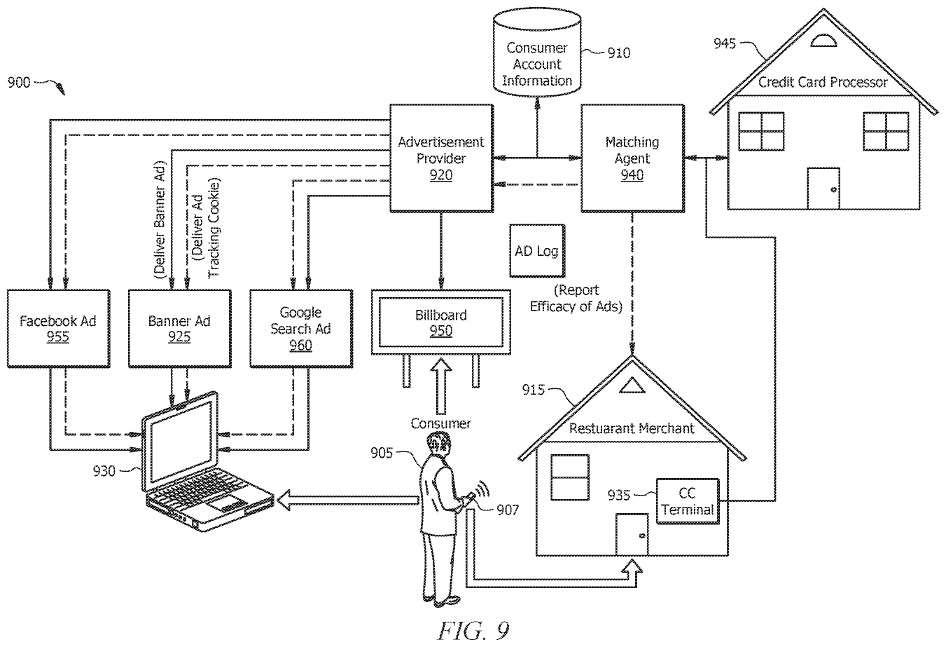

FIG. 10 illustrates an exemplary embodiment of a method for tracking of advertisement efficacy in accordance with the disclosed principles. As generally seen in the flowchart of FIG. 10 (1000), an exemplary method for transaction-based tracking of advertisement efficacy may be generally described in terms of the following steps:

(1) Presenting an advertisement to the user (1001);
The user may be presented with an advertisement via means such as online or offline by an advertising provider, which may be the merchant itself or a marketer on behalf of the merchant. Online advertisements such as banner ads, social networking ads and/or search engine ads may be presented to a user on a desktop computer or a mobile computing device. Offline advertisements may be presented to a user in the form of billboards, signs and or coupons. According to an exemplary embodiment, the user/consumer does not take explicit action by clicking on an advertisement or clipping a coupon, or by navigating to web site of the merchant being advertised.

(2) Recording and storing information, presentation mode and means of the advertisement (1002);
An information tracking agent records the advertisement information such as the user identity, merchant/advertiser, time stamp of presenting, and means of presentation through a computer or a mobile computing device such as a cell phone or smart phone, or even signage as discussed in detail above. The information tracking agent may store the advertisement information for the user in a database accessible through a network or locally.

(3) Identifying and recording a transaction by the user within a predetermined period of time (1003);
When the user of step (1001) makes a transaction such as a purchase of goods or services that are the subject of the advertisement, or simply at a merchant that was advertised, within a predetermined period of time, for example 30 days, the information tracking agent records the transaction information such as the user identity, merchant/advertiser, transaction amount, and/or transaction time stamp. For example, if the user is presented with an advertisement for a furniture store on a webpage and the user visits that furniture store within 10 days and makes a transaction with a credit card, the information tracking agent may identify the user from the credit card number and record the transaction information. The transaction may also be a non-financial transaction such as attending an event that was advertised.

(4) Matching the transaction by the user with the recorded advertisement information (1004);
A matching agent may then match the advertisement information recorded in step (1002) with the transaction information in step (1003) with a user identification and determine if a match exists. The matching agent may use criteria such as location, time stamp, and/or merchant information.

(5) Checking if a match exists, if so, proceeding to step (1007) (1005);
If a match exists in step (1004), it may indicate that the user responded to the presented advertisement in step (1001) without taking a direct action such as clicking on an advertisement or clipping a coupon.

(6) Discarding the user transaction information (1006);
The transaction information agent may discard the transaction information if a match does not exist in step (1005).

(7) Recording the matching instance and updating a database for determining advertisement efficacy (1007).
According to an exemplary embodiment, the efficacy of the advertisement presented to the user is determined by the transactions made by the user within a predetermined period of time.

One skilled in the art will recognize that these method steps may be augmented or rearranged without limiting the teachings of the present invention. This general method summary may be augmented by the various elements described herein to produce a wide variety of exemplary embodiments consistent with this overall design description.

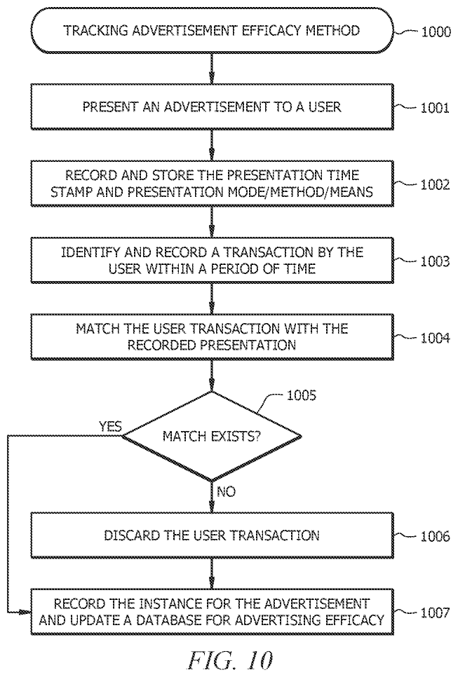

FIG. 11 illustrates an exemplary embodiment of a method for location-based tracking of advertisement efficacy in accordance with the disclosed principles. As generally seen in the flowchart of FIG. 11 (1100), an exemplary method for “location-based” tracking advertisement efficacy may be generally described in terms of the following steps:
(1) Presenting an advertisement to a user on a billboard (1101);
   A user equipped with a GPS device may drive by a billboard advertising sign. The GPS device may be a part of the automobile that the user drives or a mobile computing device carried by the user. Other location-based services and technology may also be employed with the disclosed principles.
(2) Recording and storing the location of said user (1102);
   An information tracking agent may record and store the location of the user and the location of the billboard/signage, along with a time stamp of when the advertisement was presented to the user (corresponding to when the user was located within a predetermined geographic area proximate to the advertisement.
(3) Identifying and recording a transaction by said user within a predetermined period of time and a predetermined distance from said location (1103);
   When the user of step (1101) makes a transaction such as a purchase of goods or services within a predetermined period of time, for example, 30 days, within a predetermined distance, for example, 5 mile radius, the information tracking agent records the transaction information such as the user identity, billboard merchant/advertiser, transaction amount and/or transaction time stamp. For example, if the user is presented with an advertisement for a sandwich shop on a billboard, and the user visits the sandwich shop within 10 days and makes a transaction with a credit card, the information tracking agent may identify the user from the credit card number and record the transaction information. Alternatively, the location of the user at the merchant's location (i.e., when he made the transaction) may be tracked using location-based technology, such as GPS, biometric detection, triangulation, or other location technology either now existing or later developed.
(4) Matching the transaction by said user with said billboard information (1104);
   A matching agent may match the advertisement information recorded in step (2) with the transaction information in step (1103) with a user identification and user location to determine if a match exists.
(5) Checking if a match exists, if so, proceeding to step (1107) (1105);
   If a match exists in step (1104), it may indicate that the user responded to the presented advertisement on the billboard in step (1101), and that demonstrate efficacy of the advertisement to the user.
(6) Discarding the user transaction information (1106);
   The transaction information agent may discard the transaction information if a match does not exist in step (1106).
(7) Recording the matching instance and updating a database for determining advertisement efficacy (1107).
   According to an exemplary embodiment, the efficacy of the advertisement presented to the user on the billboard is determined by the transactions made by the user within a predetermined period of time (from presentation of the advertisement) and predetermined distance from the billboard location as identified by a GPS installed in the automobile of the user or a mobile computing device of the user, or any other location tracking/determination technology. Future locations and advertisements of the billboards or other signage may be strategized based on the transactions generated by the current advertisement.

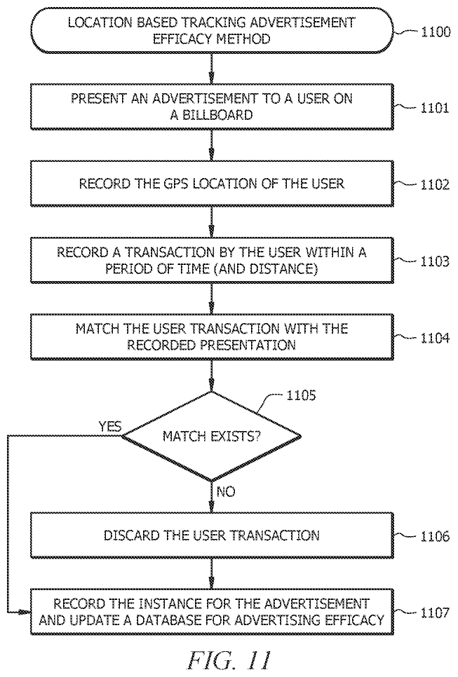

FIG. 12 illustrates an exemplary embodiment of a system for location-based real time targeted advertising in accordance with the disclosed principles, which may follow the exemplary method discussed with reference to the flowchart of FIG. 11 above. As generally illustrated in FIG. 12, a location-based real time targeted advertising system 1200 comprises an information tracking agent 1210 that keeps tracks of user locations through a GPS 1220 via a network 1230. The users may be pre-registered with the tracking agent that maintains user information such as GPS location, credit card number, unique identifier, past user history, and user trends. The user may be equipped with a GPS device installed in the automobile or a mobile computing device such as a wireless phone, a smart phone or a smart watch. The device may transmit its location via a wireless network 1240 to a GPS system 1220 or to another system in communication with the network 1230. The information tracking agent 1210 may also communicate with billboards 1250 equipped with networking devices via the network 1230.

When a user 1260 drives an automobile equipped with a GPS device, the information tracking agent 1210 tracks the user location and in real time knows or calculates a distance from the nearest billboard 1250 or other similar advertisement display. Subsequently, the information tracking agent 1210 may communicate with the billboard via the network 1230, and transmit an advertisement to the billboard 1250. According to an exemplary embodiment, the user history is analyzed in real time and the user presented an advertisement such that there is a greater likelihood of generating a transaction from the user for the goods/services that are the subject of the advertisement. The information tracking agent 1210 may use criteria such as user distance from the billboard, user past purchasing trends, and network speed to present a relevant advertisement to the user; thus, improving the efficacy of the advertisement, in addition to the efficacy tracking as discussed above.

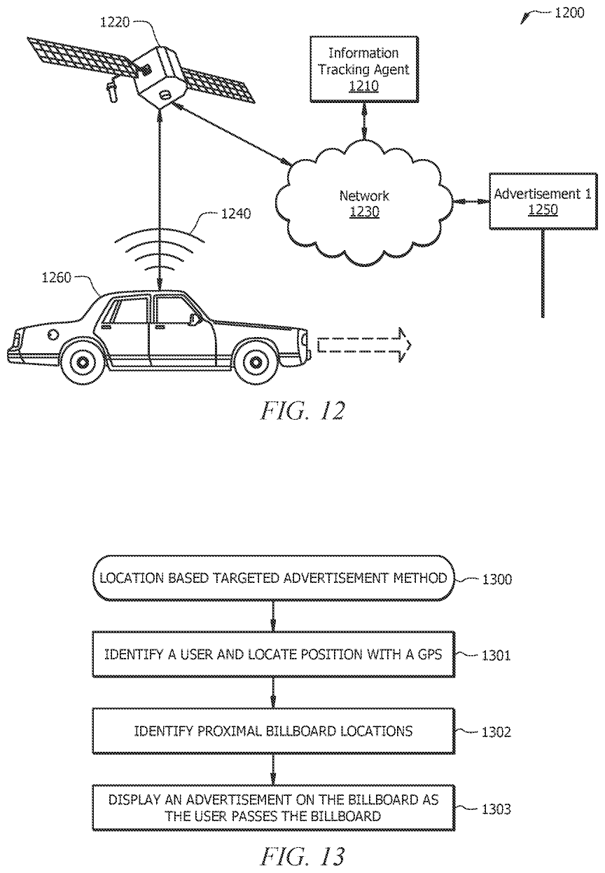

FIG. 13 illustrates a flowchart providing another exemplary embodiment of a process for location-based real time tracking of advertisement efficacy in accordance with the disclosed principles. As generally seen in the flowchart of FIG. 13 (1300), the presenting step in the aforementioned exemplary location-based tracking advertisement efficacy method(s) may further be generally described in terms of the following steps:
(1) Identifying a registered user and locate a position with a global positioning system (1301);
   With the information tracking agent, the location of a user may be determined with a GPS that is installed in the user automobile or a user mobile computing device such as a cellphone or a smart phone. Of course, as mentioned above, any type of location determining technology may also be employed with the disclosed principles
(2) Identifying billboard locations within predetermined distance to said identified user (1302); and
   With the information tracking agent, all billboards or similar signage located within a predetermined distance may be determined by GPS in real time. For example, if the user is located at Exit 5 on a given interstate highway, the information tracking agent may locate a billboard at Exit 3 that is 2 miles away from the determined present location of the user.
(3) Displaying an advertisement on said billboard, targeting said user, as said user passes by said billboard (1303).
   The information tracking agent may identify the user of step (1301) and analyze users past purchases and trends, demographic information, or even chose a random advertisement, as the case may be. For example, the information tracking agent may determine that the user is more likely to buy a sandwich based on past purchase with a registered payment vehicle or other means of determining/tracking past purchases. The information tracking agent may then communicate to the billboard within the predetermined distance and advertise a sandwich shop so that the user notices it when driving past the billboard. According to an exemplary embodiment, the information tracking agent targets an advertisement to a user in real time upon locating the user and communicating to a billboard via a network.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. An advertisement efficacy tracking system, comprising:
a computer server, embodied in both hardware and software and connected to a data network, the server configured to receive, via data transmission from an advertising provider across the data network, advertisement information regarding an advertisement of a product presented to a user by the advertising provider;
software code, for execution on a payment terminal associated with a merchant and configured to transmit transaction information regarding financial transactions at the merchant across a payment network associated with a financial institution, the software code altering functioning of the payment terminal such that it further transmits at least a portion of said transaction information to the server via the data network, said at least a portion of the transaction information comprising user transaction information regarding a financial transaction between the merchant and the user presented the advertisement for purchase of the advertised product, wherein the user transaction information comprising a unique user identifier identifying said user, an identification of said merchant, a time stamp of said financial transaction, and a unique product identifier identifying the purchased advertised product; and
a processor, embodied in both hardware and software and in communication with the server, the processor configured to:
derive mode, means and time of the presenting of said advertisement from the received advertisement information, and
determine, using the user transaction information, if the financial transaction with the user was for purchase of the advertised product by the user and occurred within a predetermined period of time from the presenting of said advertisement to the user.

2. A system in accordance with claim 1, wherein the transmitted at least a portion of said transaction information comprises unique identifying data representing a payment account number used by the user for the financial transaction with the merchant.

3. A system in accordance with claim 2, wherein the unique identifying data comprises a tokenization of the payment account number.

4. A system in accordance with claim 3, wherein the software code is further configured to cause the payment terminal to cause the tokenization of the payment account number.

5. A system in accordance with claim 1, wherein a matching agent initially receives said advertising information and user transaction information, and provides a determination that said user transaction involves purchase of the product that is the subject of the presented advertisement to the server via the data network.

6. A system in accordance with claim 1, wherein said user has registered identifying information with an entity associated with the advertisement efficacy tracking system prior to the presenting of the advertisement.

7. A system in accordance with claim 1, wherein said advertisement information comprises one or more of format of advertisement, location, time stamp, and unique product identifier of the advertised product.

8. A system in accordance with claim 1, wherein said unique identifier is selected from an identifier group consisting of: user's name, telephone number, telephone identifier, Facebook® username, Twitter® handle, an account number, a biometric, an interactive television identifier, a geographic location of the user, GPS of a mobile device, Local Area Network (LAN) device detection, device location triangulation, or Internet Protocol (IP) address of a device.

9. A system in accordance with claim 1, wherein the unique product identifier is a Stock Keeping Unit (SKU) code of the advertised product.

10. A system in accordance with claim 1, wherein said advertisement is presented to said user as an offline advertisement.

11. A system in accordance with claim 1, wherein said advertisement is presented to said user as an online advertisement.

12. A system in accordance with claim 11, wherein said online advertisement is a banner advertisement.

13. A system in accordance with claim 11, wherein said online advertisement is a search engine advertisement.

14. A system in accordance with claim 11, wherein said online advertisement is a social networking site advertisement.

15. A system in accordance with claim 1, further comprising a database, embodied in both hardware and software and in communication with the processer, the database configured to:
store the advertisement information, and
store the user transaction information.

16. A purchase tracking system, comprising:
a computer server, embodied in both hardware and software and connected to a data network;
software code, for execution on a payment terminal associated with a merchant and configured to transmit transaction information regarding financial transactions at the merchant across a payment network associated with a financial institution;
wherein the software code alters functioning of the payment terminal such that it further transmits at least a portion of said transaction information to the server via the data network, said at least a portion of the transaction information comprising user transaction information regarding a financial transaction between the merchant and a user for purchase of a product, wherein the user transaction information comprises a unique user identifier identifying said user, an identification of said merchant, a time stamp of said financial transaction, and a unique product identifier identifying the purchased product; and
a processor, embodied in both hardware and software and in communication with the server, the processor configured to determine, using the user transaction information, that the user purchased the product.

17. A purchase tracking system according to the claim 16, wherein the processor is further configured to determine, using the user transaction information, the merchant at which the user purchased the product and the time of the purchase.

18. A purchase tracking system in accordance with claim 16, wherein the unique product identifier is a Stock Keeping Unit (SKU) code of the purchased product.

19. A purchase tracking system in accordance with claim 16, wherein a matching agent initially receives said user transaction information, and provides a determination to the server via the data network that said user transaction involves the user purchasing the purchased product.

20. A purchase tracking system in accordance with claim 16, wherein said user has registered his unique user identifier with an entity associated with the purchase tracking system prior to the purchase of the product.
